(19) United States
(12) Patent Application Publication
(10) Pub. No.: US 2007/0128236 A1
(43) Pub. Date: Jun. 7, 2007

(54) Extraction process

(75) Inventor: Clive Erskine, Forestville (AU)

Correspondence Address: NEEDLE & ROSENBERG, P.C., SUITE 1000, 999 PEACHTREE STREET, ATLANTA, GA, 30309-3915, US

(73) Assignee: NATIVE FIRE ACTIVES PTY LTD., WARRAWEE (AU)

(21) Appl. No.: 10/576,384

(22) PCT Filed: Oct. 22, 2004
(86) PCT No.: PCT/AU04/01452

§ 371 Date: Jun. 9, 2006

(30) Foreign Application Priority Data
Oct. 24, 2003 (AU) 2003905881

(51) Int. Cl. A01N 65/00; A01N 25/00; C11B 1/00

(52) U.S. Cl. 424/405; 424/725; 554/8

(57) ABSTRACT

The invention relates to extracting compounds from plant material and to formulations including compounds extracted from plant material, especially but not exclusively, spray formulations for controlling pests.

### FIELD OF THE INVENTION

The invention relates to extracting compounds from plant material and to formulations including compounds extracted from plant material, especially but not exclusively, spray formulations for controlling pests.

### BACKGROUND OF THE INVENTION

Many compounds produced by plants can be used as pesticides, food additives, pharmaceuticals, cosmetics, cleaning and disinfecting agents and the like.

Compounds may be extracted from plant material by steam distillation, a process that typically involves applying steam to plant material to release volatile compounds from the plant material into steam and then condensing the steam to harvest the released volatile compounds. Alternatively, volatile compounds may be released by boiling plant material in water to release the compounds into steam and then condensing steam. Typically the extracted compounds are in the form of an oil that is insoluble in water formed by condensation. The oil is separated from water by a simple decanting process.

Solvent extraction is another process for extracting compounds from plants. This process typically involves immersing plant material in a solvent for a period of time and under conditions suitable for compounds to be extracted from the plant material into the solvent, and then physically separating the solvent from the plant material. The extracted compounds may then be separated from the solvent by evaporating the solvent in a heating step to provide a residue comprising extracted compounds. Alcohols, particularly methanol and ethanol, hydrocarbons, particularly hexane, ketones, particularly acetone, halogenated hydrocarbons, and ethers are typically used as solvents in these processes.

The step of heating plant material and/or solvent is a key feature of both the steam distillation and solvent extraction processes. Given that the desired activities of many plant compounds are destroyed or otherwise inactivated by heat (for example, a plant compound, polygodial is transformed at elevated temperatures into less active or inactive isomers; it may also react with other compounds at elevated temperatures), a limitation applies to the efficacy of these processes for extracting compounds from plant materials.

Solvents having a low boiling point, such as fluorocarbons are useful for extraction of compounds from plant material with minimal heating. However, these solvents are not environmentally friendly. Indeed some of the most effective fluorocarbon solvents for extraction of compounds from plant material, the hydrochlorofluorocarbons, are covered by ozone protection legislation that prescribes a well advanced phase-out schedule. Other hydrofluorocarbons are powerful greenhouse gases. Further they are less suitable for use as a solvent as they generally have a poor solvency power. Fluoroethers are too expensive to use as a solvent in a commercial application.

Derwent Abstract Accession Number 92-30466/37, Class B04, JP04210642-A (KAO CORP) 31 Jul. 1992 is directed to providing an extract that can be used in the treatment of cerebrovascular dementia and senile dementia including Alzheimers disease. According to the methods therein, the exact is obtained by extracting Hypercium erectum with a water or aqueous polar solvent such as glycerin, polyethylene glycol, hydrophilic surfactants and alcohols in water.

Derwent Abstract Accession Number 93-348326/44, Class B04.D21 JP 05255046-A (KAO CORP) 5 Oct. 1993 is directed to providing an extract that promotes growth of hair. According to the methods therein, the extract is obtained by extracting Gittiferae hyderiaceae with a variety of solvents.

GB 350,897 (Standard Oil Development Company) 15 Jun. 1931 is directed to fortifying or supplementing the insecticidal power of petroleum white oil with a plant extract having insecticidal properties. According to the methods therein, a plant extract is added to petroleum white oil, or otherwise a plant material is extracted in petroleum white oil.

Diemunsch A. M and Mathis C. (1983), Expo-Congr. Int. Technol. Pharm., 3^{rd}, vol. 2 pp 233-240. “Effects of aqueous glycol plant extracts on properties of aerosol foams” Publisher: Assoc. Pharm Galenique Ind., Chatenay-Malabry, Fr. (CAPLUS Abstract 1985: 600744) is directed to an aerosol foam including a propellant and liquid phase containing a surfactant, water and an aqueous glycol extract of a plant at 3-10% concentration. Propylene glycol, PEG 400 or diethylene glycol were used to extract plants such as Calendula, Hamamelis, ivy or mallow. According to the disclosure, the plant extracts improved the stability of foams, draining, collapse and the size or areoles.

Caron dos Anjos, Amaury (1967), Tribuna Farmaceutica, vo. 35(3/4), pp 53-62; 1968 36(1/4), pp 9-23; 1969 34(1), pp 49-59; 37(2), pp 135-9. “Use of surface-active (surfactant) substances in extraction processes” (CAPLUS abstract 1971:425300) is directed to liquid extraction of ipecac samples using non ionic and anionic surfactants.

DE 4205783 C1 (CASSELLA AG) 22 Jul. 1993 is directed to extracting compounds using an aqueous solvent.

Choi Maggie P. K. et al., (January 2003) J. Chrom. vol 983 pp 153-162 “Pressurized liquid extraction of active ingredients (ginsenosides) from medicinal plants using non-ionic surfactants” is directed to determining the effectiveness of employing an aqueous solution containing a common non-ionic surfactant (Triton X-100) as the extracting medium in pressurized liquid extraction (PLE) and ultrasonic-assisted extraction by comparing with conventional extraction solvents such as water and methanol as a function of experimental parameters such as temperature, pressure and concentration of the surfactant.

Huie C. W. (200) Anal Bioanal Chem vol. 373, pp 23-30. “A review of modern sample-preparation techniques for the extraction and analysis of medicinal plants” is a review of developments and applications of sample-preparation techniques for the extraction, clean-up and concentration of analytes from plants including solid-phase microextraction, supercritical-fluid extraction, pressurized-liquid extraction, microwave assisted extraction, solid phase extraction and surfactant mediate extraction.

WO2001/15534A1 (Australian Native Foods Resource Development Pty Ltd) 8 Mar. 2001 is directed to an insecticidal extract of Tasmannia stipitata. The extract is obtained by solvent extraction.

WO 01/07135 (Pisacane) 1 Feb. 2001 is directed to extracting materials from plants using solvents derivable from plants and especially terpenes and plant oils comprising terpenes such as rosemary oil and lavender oil, to obtain an insecticide. According to WO 01/07135, terpene-based solvents are required to extract a compound that, according to WO 01/07135, is a mixture of terpenes.

FR 2448 856 (SAPHYR SARL) 12 Sep. 1980 is directed to solvent extraction of compounds from plants.

There is a need for improved processes for extracting compounds that have useful activities from plant material.

### SUMMARY OF THE INVENTION

In one aspect there is provided a method for extracting a compound from a plant material including:

providing an extractant including a fatty acid ester
contacting the extractant with a plant material to extract a compound from the plant material.

In another aspect there is provided a method for producing a spray formulation including:

providing an extractant including a non sulfonated triacyl glycerol and/or fatty acid ester

contacting the extractant with a plant material to form an extract of pestidicidal compounds from the plant material

optionally adding a pesticidally active oil to the formed extract, to produce a spray formulation.

In another aspect there is provided a spray formulation produced by the above described method.

In another aspect there is provided a method for producing a food additive or ingredient from a plant material including:

providing an extractant including a triacyl glycerol and/or fatty acid ester

contacting the extractant with a plant material to produce a food additive or ingredient from the plant material.

In another aspect there is provided a method for producing a pharmaceutical compound from a plant material including:

providing an extractant including a fatty acid ester

contacting the extractant with a plant material to produce a pharmaceutical compound from the plant material.

In another aspect there is provided a method for producing a cosmetic compound from a plant material including;

providing an extractant including a fatty acid ester

contacting the extractant with a plant material to produce a cosmetic compound from the plant material.

In another aspect there is provided a method for producing a reagent for use in a cleaning or disinfecting agent from a plant material including:

providing an extractant including a triacyl glycerol and/or fatty acid ester

contacting the extractant with a plant material to produce a reagent for use in a cleaning or disinfecting agent from a plant material.

### DETAILED DESCRIPTION OF THE INVENTION

It has been surprisingly found that fatty acid esters can be used as an extractant, or in other words, a solvent, to extract a variety of useful compounds from plant material, especially plant material obtained from Australian native plant species.

Further it has been found that fatty acid esters provide a much higher solvency power to the extractant than would otherwise be provided by a triglyceride—containing oil or other oil. Accordingly, one key advantage of the method is that it provides for an improved selectivity for extraction of a compound of interest from a plant material.

Advantageously, it is possible to adjust the polarity of the extractant, and so select certain molecules for extraction from plant material in preference to others, by selecting particular types of fatty acid esters for use in the extractant.

Another key advantage of a higher solvency power is that an extract containing a high concentrate of a desired plant compound can be obtained. This is particularly important for those applications where downstream processing to provide for example a pesticide, food additive, pharmaceutical in cosmetic, tends to result in an undesirable dilution of compound in a plant extract.

Accordingly, in one aspect there is provided a method for extracting a compound from a plant material including:

providing an extractant including a fatty acid ester

contacting the extractant with a plant material to extract a compound from the plant material.

Typically the fatty acid ester is an ester selected from a group consisting of methyl, ethyl, propyl and butyl esters, although other fatty acid esters are within the scope of the invention. Further examples of fatty acid esters include pentyl, hexyl, heptyl, octyl, nonyl, decyl, undecyl and dodecyl esters.

It will be understood that the fatty acid ester for use in the extractant may be derived by any process for derivation of a fatty acid ester known to the skilled worker. For example, the fatty acid ester could be obtained by chemical synthesis from a precursor molecule, such as an alkyl. Alternatively, the fatty acid ester could be obtained by an enzymatic catalysis of pre-cursor molecules, such as occurs in the cleavage of fatty acyl chains from glycerol with lipase.

Another way of deriving the fatty acid ester for use in the extractant is by esterification of a triglyceride. For example, a triglyceride—containing oil, such as a vegetable or animal oil may be reacted with an alcohol such as methanol or ethanol in the presence of an alkaline catalyst to produce a mixture of fatty acids and glycerol. For example, canola oil is rich in oleic acid, generally containing greater than 60% and often 80% by weight oleic acid. This oleic acid, together with other fatty acids such as linolenic acid is present in canola in the form of triglycerides. When the oil is reacted with ethanol in the presence of an alkaline catalyst at about 50° C., a mixture of glycerol and fatty acid esters is formed. The glycerol is then removed, leaving a mixture rich in the ethyl ester of oleic acid.

Examples of fatty acid esters that may be obtained by esterification of vegetable oils include oleic acid, methyl ester; oleic acid, ethyl ester, and octadecanoic acid, butyl ester.

Examples of animal oils that could be used to derive fatty acid esters for use in the extractant include tallow, lard, wool grease, fish oils.

Examples of vegetable oils that could be used to derive fatty acid esters for use in extractant include soyabean, sunflower, safflower, canola, cotton, coconut, castor, corn, linseed, peanut palm, hemp, rice bran, tung, jojoba and olive oil.

The extractant may further include one or more of a polar oil, a non polar oil, and a surfactant. These are particularly useful for modifying the selectivity of the extractant for extraction of compounds in plant material.

Examples of polar oils include oils that contain one or more of triglycerides, terpenes and various oxygen containing compounds from terpenes such as alcohols, eg tepineol, ketones and camphors, limxonene and pinenes. Rosemary oil and lavender oil are examples of plant oils that contain terpenes. Other examples include tea tree, eucalyptus, orange, lemon, pine and cypress. Polar oils maybe useful in the extractant for extraction of polar compounds from plant material.

Examples of non polar oils include mineral oils, such as paraffin, white oil and the like. These may have a carbon chain length in the range of C12 to C28. Other examples of non polar oils include petroleum oils. Non polar oils may be useful in the extractant for extraction of non poplar compounds from plant material.

Typically, the polar and non polar oils are miscible with the fatty acid ester in the extractant.

Typically the surfactant is a non ionic surfactant, although other surfactants may be used. Non ionic surfactants are preferred especially where the extract is to be used in a stray formulation. Examples of non ionic surfactants include polyethylene glycol dioleate; 9-octadecanoic acid monoester with 1,2-propanediol; ethoxylated sorbitan trioleate; polyethylene glycol, monococonut ester; polyethylene glycol, monooleate; diethylene gycol, monooleate; glycerol monooleate, propylene glycol monooleate.

Typically, the extractant contains about 20 to 90% by weight of fatty acid esters and may contain 2-30% by weight of surfactant. One example is an extractant that contains 15% surfactant, 35% fatty acid esters and 50% non polar oil. Other examples of surfactants are those having components in the following ranges: 5-30% surfactant; 20-95% fatty acid esters; and 0-60% non polar oil.

The extractant may further include a solvent for solubilising certain molecules in the plant material, otherwise known as a second solvent. Examples of these solvents include ethanol, acetone, glycerol and hexane. These may comprise from about 5% to 50% by weight of the extractant.

Depending on the type of fatty acid ester and other components of the extractant, the plant material and the intended use of the compounds to be extracted from the plant material, the above ranges can be broader.

The method can be applied to a wide variety of plants including the following Autralian native plants:

Plants of the genus Callitris, in particular Callitris glaucophylla and Callitris endlicheri

Plants of the genus Tasmannia, in particular Tasmannia stipitata and Tasmannia lanceolata

Plants of the genus Leptospermum, in particular Leptospermum polygalifolium, Leptospermum petersonii, Leptosermum grandiflorum, Leptospermum neglectum, Leptospermum speciosum, Leptospermun brevipes, Leptospemum oreophiilum and Leptospermum gregarium.

Plants of the genus Prostanthera, in particular Prostanthera incisa and Prostanthera rotundifolia

Plants of the genus Rhodamnia, in particular Rhodamnia whiteana and Rhodamnia argentea

Plants of the genus Eremophila, in particular Eremophila mitchelii

Plants of the genus Melaleuca, in partcular Melaleuca uncinta, Melaleuca stypheloides, Melaleuca quinquenervia and Melaleuca altenifolia

Plants of the genus Phebalium, in particular Phebalium squameum and Phebalium dentatum

Plants of the genus Eucalyptus, in paricular Eucalyptus melanophloia and Ezcalyptus cloeziana

Plants of the genus Acacia, in particular Acacia howittii

Other plants including Cryptocaria cunninghamii, Austromyrtus dulcis, Backhousia citriodora and Backhousia anisata (also known as Anetholea anisata) Pesticidally active compounds can, for example, also be extracted from the following plants not native to Australia;

Polygoman hydropiper

Azadirachta indica (neem)

Chrysanthemum cinerariaefolium (pyrethrum)

Ginkgo biloba

Nicotiana tabacum (tobacco)

Derris elliptica

Melia azadirachta

Warburgia stuhlmannii

Warburgia ugandensis

Cannella winterana

Drimys winteri

Ailanthus altissima

Glycosmis species

Anabasis aphylia

Ryania speciosa

The plant material may include the whole or any part of a plant, including leaves, flowers, trunks, butts and roots.

Typically the plant material is pre-treated so that it is in an appropriate physical form to facilitate the extraction of the compounds. Typically this includes treating the plant material to increase the surface area of the plant material, so that contact between the plant material and the extractant is increased. Commonly, some form of comminution process is used to reduce the particle size of the plant material. A particle size with a maximum dimension of 1-3 mm is normally adequate to achieve a good yield.

In some cases, the moisture content of the plant material is also reduced prior to contacting the plant material with the solvent. The reduction in moisture content should be carried out in a manner which minimises the loss of any volatile compounds desired to be extracted from the plant material, and minimises the destruction or inactivation of compounds desired to be extracted from the plant material.

Typically, the plant material is contacted with the solvent by passing the solvent past the plant material, or immersing the plant material in the solvent.

The extraction process may for example be cared out by the following procedure:
1. The solvent is placed in a vessel, preferably a vessel equipped with a high shear mixer. Where high shear agitation is used, it may not be necessary to reduce the particle size of the plant material prior to contacting the plant material with the solvent as this may occur during the mixing of the plant material and solvent.
2. Agitation of the solvent is commenced and the plant material is added progressively.
3. Optionally, if the compounds of interest are not heat sensitive, the mixture may be heated to enhance extraction rate and yield.
4. Agitation is continued until the plant material is dispersed and the extraction process is proceeding. Alternatively, agitation can be continued throughout the extraction process.
5. When a suitable amount of compounds have been extracted, the mixture is removed from the vessel and filtered or centrifuged to separate the solvent containing the extracted compounds from the plant material.
6. Additional extract may be obtained by subjecting the residue of plant material to pressure.
7. Beneficiation processes may be performed on the solvent containing the extracted compounds as necessary. For example, additional filtration steps can be performed, any moisture present in the solvent can be removed and/or the solvent can be passed through charcoal or activated clay to remove any colouring matter. Beneficiation can also involve the addition of other compounds, such as quinic, ascorbic or citric acid, to improve the stability of, and enhance the efficacy of, the extracted compounds, or the addition of antioxidants such as tocopherols to further enhance stability and product shelf life.

The above process can, for example, be used to extract the compound citral from leaves of Backhousia citriodora (lemon myrtle) which have been air dried and milled to a particle size of 2 mm, using a solvent consisting of a mixture of an esterified vegetable oil, a non polar oil and non-ionic surfactants. Citral is known to possess useful fungicidal properties.

In an alternative extraction process, the plant material may be contacted with the solvent by placing the plant material in contact with the solvent, and leaving the plant material in contact with the solvent for a few days (for example 2 to 4 days) to several weeks typically at room temperature. The amount of time the plant material is left in contact with the solvent will vary depending upon the particle size of the plant material, the temperature, the solvency power of the solvent and the desired yield of the extracted compounds.

The method is typically carried out at room temperatures (for example at about 10° C. to about 30° C.). However, if the compounds to be extracted are not heat sensitive, the methods can be carried out at higher temperatures.

Depending on the plant species, a variety of compounds can be extracted from plant material, including those that can be used as a pesticide, for example, an insecticide, termiticide, fungicide, bactericide etc. Examples of pesticidally active compounds that can be extracted from plant material using the method include, for example, citral, polygodial, anethole, azadirachtin, citronellal, alpha and beta pinene, caryophyllene, gualol, linalool pyrethrum, quinine, terpineol and vanillia.

An extract including pesticidal compounds obtained by the above described process may be added to a carrier or excipient to provide a pesticidal composition. A pesticidally active oil is a preferred excipient. A pesticidally active oil is an oil that repels or kills or otherwise affects pests, especially arthropod pests that cause damage to plants and/or transfer microorganisms that cause fungal or bacterial diseases to plants, and/or repels kills or otherwise adversely affects microorganisms that cause fungal or bacterial disease in plants. Paraffinic oils are an example of a pesticidally active oil.

The invention is particularly useful for providing a spray formulation. A spray formulation has a high quantity of a pesticidally active oil, and is typically sprayed onto a plant surface as an emulsion with water. Spray formulations typically comprise about 80% to 90% by weight of one or more pesticidally active oil(s) and about 2% to 20% by weight of one or more surfactant(s). The spray formulation may also contain a small amount, for example up to about 10% by weight of other components.

Thus, in another aspect there is provided a method for producing a spray formulation including:

providing an extractant including a non sulfonated triacyl glycerol and/or fatty acid ester

contacting the extractant with a plant material to form an extract of pestidicidal compounds from the plant material

optionally adding a pesticidally active oil to the formed extract, to produce a spray formulation.

In one particularly preferred embodiment, the extractant includes a pesticidally active oil. This is advantageous, because it avoids the dilution of the extracted compound that would otherwise occur when an extract is added to a pesticidally active oil to produce a spray formulation.

According to the method, a surfactant as described above may be added to the extractant before extraction of pesticidal compounds from plant material. Alternatively, the surfactant may be added after extraction of the pesticidal compounds.

Further, a polar and/or non polar oil and other solvents as described above may be added to the extractant before extraction, or they may be added after extraction.

In another aspect there is provided a spray formulation produced by the above described method. The spray formulation may contain by weight, 10% surfactants and 90% C16-C20 paraffinic oil. The oil may be applied to plants as a 1-2% emulsion in water.

The method of the invention also has utility in providing compounds with application as a pharmaceutical, a food additive, such as a colouring or flavouring agent, a cosmetic or fragrance or surface cleaning agent.

Thus, in another aspect there is provided a method for producing a food additive or ingredient from a plant material including:

providing an extractant including a triacyl glycerol and/or fatty acid ester

contacting the extractant with a plant material to produce a food additive or ingredient from the plant material.

As an example, the fruit of paprika contains a strongly coloured oleoresin. According to the invention, dried, milled paprika fruit can be contacted with an extractant of 20% esterified fatty acids and 80% sunflower oil. The extract obtained can be used as flavouring in foods and as a colorant in cosmetic preparations.

In another aspect there is provided a method for producing a pharmaceutical compound from a plant material including:

providing an extractant including a fatty, acid ester

contacting the extractant with a plant material to produce a pharmaceutical compound from the plant material.

As an example, the leaves of the plant Mebaleuca alternifolia, referred to as “tea tree” contain compounds used in pharmaceutical preparations. These compounds can be extracted by contacting the leaves of Melaleuca alternifolia with fatty acid esters and the extract obtained formulated into creams and lotions for topical application.

In another aspect there is provided a method for producing a cosmetic compound from a plant material including:

providing an extractant including a fatty acid ester

contacting the extractant with a plant material to produce a cosmetic compound from the plant material.

For example, the seeds of species of plants of the genus Echium are known to contain a fatty acid known as stearidonic acid. Stearidonic acid has use both as a nutritional supplement and has been shown to have anti-wrinkle properties when applied topically. The crushed seed of the plant Echium plantagieum can be contacted with fatty acid esters to extract a mixture of fatty acids including stearidonic acid. The extract obtained can be used as a nutitional supplement or formulated into creams and lotions for topical application.

In another aspect there is provided a method for producing a reagent for use in a cleaning or disinfecting agent from a plant material including:

providing an extractant including a triacyl glycerol and/or fatty acid ester

contacting the extractant with a plant material to produce a reagent for use in a cleaning or disinfecting agent from a plant material.

The invention is described below by reference to certain non-limiting examples. It will be appreciated by persons skilled in the art that numeous variations and/or modifications may be made to the invention as described in the examples without departing from the spirit or scope of the invention as broadly described. The following examples are, therefore, to be considered in all respects as illustrative and not restrictive.

### EXAMPLES

### Example 1

The following table shows a comparison between insecticidal efficacy of a solvent containing compounds extracted from plant material prepared by the method of the present invention using the product Hasten™ as the solvent (Victorian Chemicals Pty Ltd, 37-49 Appleton St, Richmond VIC 3121 Australia), versus a comparable extract produced using the solvent dimethyl sulphoxide. Hasten™ comprises ethylated canola oil blended with non-ionic surfactants. Dimethyl sulphoxide is a solvent which may be used in conventional solvent extractions of plant materials and is regarded as a powerful solvent.

In each case, dried leaves of Tasmannia stipitata from the same bulk sample were used. The same extraction process was carried out for each solvent. The solvent was placed in a vessel equipped with a high shear mixer. Agitation of the solvent was commenced and the plant material added progressively. Agitation was continued until the plant material was dispersed in the solvent. Agitation was then stopped and the mixture allowed to stand at room temperature for 24 hours. The plant material was then separated from the solvent by filtration.

The solvent containing the compounds extracted from the plant material was mixed with water at the percentage by volume listed in the table below (CONC %), and the mixture sprayed on a surface containing Two Spotted Mites and the mortality, feeding and egglaying of the mites was observed. The results are reported in the table below.

| | | MEAN TWO | |
|---|---|---|---|
| | | SPOTTED | |
| | | MITE (TSM) | |
| | | MORTALITY | |
| PRODUCT | CONC (%)* | 24 h (%) | COMMENTS |
| Tasmannia | | | Formed emulsion |
| stipitata | 0.5 | 62.7 | No TSM eggs, no feeding |
| extracted with | | | |
| esterfied | 1.0 | 98.4 | TSM convulsing |
| vegetable oil and | 2.0 | 100 | Some phytoxicity |
| surfactants | 4.0 | 100 | High phytoxicity |
| | 8.0 | 100 | High phytoxicity |
| Tasmannia | | | Formed clear solution |
| stipitata | 0.5 | 3.9 | Normal TSM feeding and |
| extracted with | | | egglaying |
| dimethyl | 1.0 | 2.8 | Some TSM eggs, |
| sulphoxide | | | convulsing |
| | 2.0 | 66.2 | No TSM eggs, no feeding |
| | 4.0 | 92.9 | TSM convulsing, some |
| | | | phytoxicity |
| | 8.0 | 100 | Phytoxicity |

*CONC (%) refers to the percentage by volume of the total extract (i.e. the compounds extracted from the plant material and the solvent) dispersed in water.

This example demonstrates that the solvent containing the extracted compounds produced by the method of the present invention had pesticidal activity against Two Spotted Mites.

### Example 2

The method for extracting compounds from plant material described in Example 1 was repeated using the leaves of Tasmannia stipitata and the product “Hasten” as the solvent, to produce a solvent containing compounds extracted from the leaves of Tasmannia stipitata. The solvent containing the extracted compounds was in the form of a dilute dark green solution. The solvent containing the extracted compounds was combined 50% w/w with a C24 paraffinic spray oil to produce a clear, greenish coloured formulation. This formulation can be used as a spray formulation.

1. A method for extracting a compound from a plant material including:
providing an extractant including a fatty acid ester
contacting the extractant with a plant material to extract a compound from the plant material.

2. A method according to claim 1 wherein the fatty acid ester is selected from a group consisting of methyl, ethyl, propyl, butyl, pentyl, hexyl, heptyl, octyl, nonyl, decyl, undecyl and dodecyl esters.

3. A method according to claim 1 wherein the fatty acid ester is produced by esterification of an animal or vegetable oil.

4. A method according to claim 3 wherein the vegetable oil is selected from a group consisting of soyabean, sunflower, safflower, canola, cotton, coconut, castor, corn, linseed, peanut, palm, hemp, rice bran, tung, jojoba and olive oil.

5. A method according to claim 3 wherein the animal oil is selected from a group consisting of tallow, lard, wool grease and fish oils.

6. A method according to claim 1 wherein the extractant further includes one or more of a polar oil, a non polar oil and a surfactant.

7. A method according to claim 6 wherein the polar oil is a vegetable or animal oil.

8. A method according to claim 6 wherein the non polar oil is a mineral or petroleum oil.

9. A method according to claim 6 wherein the surfactant is a non ionic surfactant.

10. A method according to claim 6, further including a solvent for a compound of the plant material.

11. A method according to claim 6 wherein the extractant is a mixture of about 70% to about 90% by weight of a fatty acid ester and about 10 to about 30% by weight of one or more of a polar oil, a non polar oil a surfactant and an agent for stabilising an emulsion.

12. A method according to claim 10 wherein the solvent for a compound of the plant material is about 5 to about 50% by weight of the fatty acid ester.

13. A method according to claim 1 wherein the plant material is selected from a group consisting of Tasmannia stipitata, Prostanthera incisa, Callitris glaucophylla and Backhousia citriodora.

14. A method for producing a pesticidal spray oil formulation including:
providing an extractant including a non sulfonated triacyl glycerol and/or fatty acid ester
contacting the extractant with a plant material to form an extract of compounds from the plant material
optionally adding a pesticidally active oil to the formed extract, to produce a pesticidal spray oil formulation.

15. A spray oil formulation produced by the method of claim 14.

16. (canceled)

17. (canceled)

18. (canceled)

19. (canceled)
